(19) United States
(12) Patent Application Publication
(10) Pub. No.: US 2006/0270055 A1
(43) Pub. Date: Nov. 30, 2006

(54) Method for testing external influences on biological tissues

(75) Inventors: Fritz-Albert Popp, Neuss (DE); Sophie Cohen, Grevenbroich (DE); Yu Yan, Neuss (DE)

Correspondence Address: BUCHANAN, INGERSOLL & ROONEY PC, POST OFFICE BOX 1404, ALEXANDRIA, VA, 22313-1404, US

(73) Assignee: Bohler GMBH, Braunchweig (DE)

(21) Appl. No.: 10/557,827

(22) PCT Filed: Mar. 23, 2004
(86) PCT No.: PCT/DE04/00589

§ 371 Date: Nov. 23, 2005

(30) Foreign Application Priority Data
Apr. 25, 2003 (DE) 10319043.0

(51) Int. Cl. G01N 21/64

(52) U.S. Cl. 436/172

(57) ABSTRACT

The invention relates to a method for testing external influences on biological systems by measuring “ultraweak photon emissions (biophotons) and “delayed luminescence”, based on non-local and different changes of photon emissions on different points of the tissue through exposure to the external influence. The changes can vary to such an extent that the slightest differences in the influences can be can be registered with the highest sensitivity.

The invention relates to a method for testing external influences on biological tissue, including that of human beings, by using local and non-local reactions of biophoton emission (ultraweak photon emissions from biological systems).

Known from EP-A-0430150 is that slight differences in the reaction of biological systems to some kind of influences can be quickly, reliably and non-invasively detected by means of biophoton emissions or delayed luminescence. These methods are based on measuring the intensity of weak light emissions from biological systems (“biophotons”) without and after external excitation, and utilize the differences in intensity or differences in characteristic decay functions of the delayed luminescence to draw conclusions as to the effect or effectiveness of the influencing variables.

By contrast, the object of the invention is to find a method for testing the effect or effectiveness of external influences on biological tissue, e.g., including that of human beings, which makes it possible to ascertain differences in the influencing variables and in their effect that are smaller than could previously be found non-invasively.

This object is achieved with the features of the patent claim.

The invention is based on measuring the ultraweak photoemissions not just at the treated location of the respective object, but also on other, different points of the tissue that were not directly exposed to the external influence. Specifically, it was surprisingly discovered that many, if not most, external influences also trigger changes in photoemission on parts of the tissue that were not directly treated. Comparing the “responses” on tissue sections that were not directly treated to “responses” on treated tissue sections as reflected in the changes in the respective intensities of the ultraweak photoemissions yields important indices for the effect or effectiveness of the examined influence (“stimulus”). It may here be advantageous to also use filter systems or polarizers.

The invention will be described in greater detail below in an exemplary embodiment.

The right arm of a test subject suffering from a skin disease is irradiated with a UV lamp (hanseatic type, Schott type 816 Ee, 230 V, 105 W, UV type 3) for 5 minutes. The irradiated surface consists of partially diseased, partially healthy tissue. The left arm is symmetrically affected in the same way. Table 1 shows the measured values for spontaneous photoemission (PE, in counts/s) and initial values for delayed luminescence after 10 s of exposure to a 150 W tungsten lamp (NB, in counts/s) before, immediately after and 1 hour after treatment.

| | Diseased region | | Relatively healthy region | |
|---|---|---|---|---|
| | PE | NB | PE | NB |
| Treated arm | | | | |
| Before treatment | 11.0 | 1,030 | 9.9 | 1,105 |
| After treatment | 44.4 | 670 | 39.5 | 975 |
| 1 hour later | 13.6 | 920 | 13.6 | 1,695 |
| Untreated arm | | | | |
| Before treatment | 11.2 | 920 | 9.7 | 995 |
| After treatment | 12.2 | 1,000 | 14.5 | 1,160 |
| 1 hour later | 11.0 | 1,060 | 9.7 | 1,450 |

The example shows that responses of significance for understanding the treatment process and its influences on the tissue arise not just at the treated location, but also at the untreated locations. These reactions can also be of importance for testing external influences. There are no other methods for this purpose.

1. A method for testing external influences on biological systems by measuring “ultraweak” photon emissions and delayed luminescence, wherein the photon intensities of the objects are measured locally and nonlocally at different points of the tissue before and after application of external influences agents.

2. The method according to claim 1, wherein a measuring chamber according to G9417845.3 is used.

3. The method according to claim 1, wherein the dynamic progression of the changes in ultraweak photon emissions and delayed luminescence is measured within several hours.

4. The method according to claim 1, wherein filter systems (spectral filters and/or polarization filters, phase shifters) are used.
